(19) United States
(12) Patent Application Publication
(10) Pub. No.: US 2026/0051757 A1
(43) Pub. Date: Feb. 19, 2026

(54) CHARGING/DISCHARGING PROBE, CHARGING/DISCHARGING JIG, AND CHARGING/DISCHARGING APPARATUS

(71) Applicant: Samsung SDI Co.,Ltd., Yongin-si (KR)

(72) Inventors: Jaelim Ryu, Yongin-si (KR); Jaehyun Yoo, Yongin-si (KR); Soohwan Park, Yongin-si (KR)

(73) Assignee: Samsung SDI Co.,Ltd., Yongin-si (KR)

(21) Appl. No.: 19/276,570

(22) Filed: Jul. 22, 2025

(30) Foreign Application Priority Data
Aug. 13, 2024 (KR) 10-2024-0108105

(51) Int. Cl. H02J 7/00; H01M 4/04; H01M 10/42; H01M 10/44

(52) U.S. Cl. CPC H02J 7/0069; H01M 4/0447; H01M 10/4285; H01M 10/44; H02J 7/0045; H02J 7/0047

(57) ABSTRACT

Disclosed are a charging/discharging probe, a charging/discharging jig, and a charging/discharging apparatus. The charging/discharging probe is a charging/discharging probe in contact with an electrode terminal of a secondary battery in a charging/discharging jig used for charging, discharging, or testing of the secondary battery, and may include: a jig terminal electrically connected to the electrode terminal of the secondary battery in contact with the electrode terminal; a guide rod coupled to a connection portion with a frame of the charge/discharge jig and the jig terminal and made of an elastic member; and a spring formed to surround a part of the jig terminal and the guide rod and allowing the guide rod to elastically fix the electrode terminal of the secondary battery.

### CROSS-REFERENCE TO RELATED APPLICATIONS

This present application claims priority to and the benefit under 35 U.S.C. § 119(a)-(d) of Korean Patent Application No. 10-2024-0108105, filed on Aug. 13, 2024, in the Korean Intellectual Property Office, the entire disclosure of which is incorporated herein by reference.

### FIELD

Aspects of some embodiments of the present disclosure relate to a charging/discharging probe, a charging/discharging jig, and charging/discharging apparatus, and to a charging/discharging probe including a guide rod made of an elastic member, a charging/discharging jig, and a charging/discharging apparatus.

### BACKGROUND

Unlike primary batteries that are not designed to be charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. The secondary battery includes an electrode assembly consisting of a positive electrode and a negative electrode, a case that accommodates the electrode assembly, a terminal part connected to the electrode assembly, etc.

Secondary batteries are manufactured and then shipped after going through a battery activation step. The battery activation step includes a process of mounting a secondary battery on a secondary battery charging/discharging jig and then charging/discharging the secondary battery under conditions necessary for activation. In addition, the performance of the secondary battery is also tested, and such a test for the performance of the secondary battery is generally performed by mounting the secondary battery on the charging/discharging jig used in the activation step, connecting a measuring terminal for measuring electrical characteristics such as voltage, current, or resistance to an electrode terminal, and measuring the electrical characteristics.

In a charging/discharging jig in the related art, in the process of coupling a secondary battery, a charging/discharging probe of the charging/discharging jig is coupled to an electrode terminal of the secondary battery. In such a circumstance, the charging/discharging probe of the charging/discharging jig may be coupled while the electrode terminal of the secondary battery is tilted. In such a circumstance, there is a problem in that additional contact resistance occurs due to poor contact between the charging/discharging probe and the electrode terminal and charging/discharging or test is not possible due to a change in the contact resistance between the charging/discharging probe and the electrode terminal.

The above information disclosed in this Background section is for enhancement of understanding of the background of the present disclosure, and therefore, it may contain information that does not constitute related (or prior) art.

### SUMMARY

An object of the present disclosure is to provide a charging/discharging probe including a guide rod made of an elastic member, a charging/discharging jig, and a charging/discharging apparatus.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

A charging/discharging probe according to embodiments of the present disclosure is a charging/discharging probe in contact with an electrode terminal of a secondary battery in a charging/discharging jig used for charging, discharging, or testing of the secondary battery, and may include: a jig terminal electrically connected to the electrode terminal of the secondary battery; a guide rod coupled to a connection portion with a frame of the charge/discharge jig and the jig terminal and made of an elastic member; and a spring formed to surround a part of the jig terminal and the guide rod and allowing the guide rod to elastically fix the electrode terminal of the secondary battery.

In embodiments, the guide rod may be a plate spring.

In embodiments, the guide rod may be coupled to a groove formed in the connection portion with the frame of the charge/discharge jig and the jig terminal.

In embodiments, the charging/discharging probe may further include a temperature measurement unit that measures a temperature of the jig terminal.

In embodiments, the charging/discharging probe may further include a contact resistance measurement unit that measures a contact resistance of the jig terminal.

In embodiments, the jig terminal may include a spring pogo pin on a contact surface with the electrode terminal of the secondary battery.

In embodiments, when the spring pogo pin comes into contact with the electrode terminal of the secondary battery, the contact resistance measurement unit may measure the contact resistance of the jig terminal.

A charging/discharging jig according to embodiments of the present disclosure is a charging/discharging jig used for charging, discharging, or testing of a secondary battery and may include: a frame on which the secondary battery is seated; and a charging/discharging probe in contact with an electrode terminal of the secondary battery, wherein the charging/discharging probe may include: a jig terminal electrically connected to the electrode terminal of the secondary battery in contact with the electrode terminal; a guide rod coupled to a connection portion with a frame and the jig terminal and made of an elastic member; and a spring formed to surround a part of the jig terminal and the guide rod and allowing the guide rod to elastically fix the electrode terminal of the secondary battery.

In embodiments, the guide rod may be a plate spring.

In embodiments, a groove may be formed in the connection portion with the frame and the jig terminal, and the guide rod may be coupled to the groove formed in the connection portion with the frame and the jig terminal.

In embodiments, the charging/discharging probe may further include a temperature measurement unit that measures a temperature of the jig terminal.

In embodiments, the charging/discharging probe may further include a contact resistance measurement unit that measures a contact resistance of the jig terminal.

In embodiments, the jig terminal may include a spring pogo pin on a contact surface with the electrode terminal of the secondary battery.

In embodiments, when the spring pogo pin comes into contact with the electrode terminal of the secondary battery, the contact resistance measurement unit may measure the contact resistance of the jig terminal.

A charging/discharging apparatus according to embodiments of the present disclosure is a charging/discharging apparatus used for charging, discharging, or testing of a secondary battery and may include: a charging/discharging jig including a frame on which the secondary battery is seated and a charging/discharging probe in contact with an electrode terminal of the secondary battery; and a control unit that controls the charging, discharging, or test of the secondary battery, wherein the charging/discharging probe may include: jig terminal electrically connected to the electrode terminal of the secondary battery in contact with the electrode terminal; a guide rod coupled to a connection portion with a frame and the jig terminal and made of an elastic member; and a spring formed to surround a part of the jig terminal and the guide rod and allowing the guide rod to elastically fix the electrode terminal of the secondary battery.

In embodiments, wherein the charging/discharging probe may further include a temperature measurement unit that measures a temperature of the jig terminal.

In embodiments, when the temperature of the jig terminal is equal to or higher than a predetermined temperature value, the control unit may determine that a contact between the jig terminal and the electrode terminal of the secondary battery is poor.

In embodiments, the charging/discharging probe may further include a contact resistance measurement unit that measures a contact resistance of the jig terminal.

In embodiments, the jig terminal may include a spring pogo pin on a contact surface with the electrode terminal of the secondary battery.

In embodiments, when the spring pogo pin comes into contact with the electrode terminal of the secondary battery, the contact resistance measurement unit may measure the contact resistance of the jig terminal, and when the contact resistance of the jig terminal is equal to or greater than a predetermined resistance value, the control unit may determine that a contact between the jig terminal and the electrode terminal of the secondary battery is poor.

According to embodiments of the present disclosure, by providing the guide rods each made of an elastic member, poor contact between the charging/discharging probes and the electrode terminals due to the collapse of the horizontality between the electrode terminals of the secondary battery can be prevented.

According to embodiments of the present disclosure, even though the horizontality of the electrode terminal of the secondary battery collapses, the guide rods are each configured as a plate spring, so that the jig terminals can flexibly move left and right, thereby preventing poor contact and enabling smooth charging and discharging or test of the secondary battery.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIG. 1A is a top perspective view of a prismatic secondary battery;

FIG. 1B is a cross-sectional view taken along line I-I in FIG. 1A;

FIG. 2A to FIG. 2C are diagrams illustrating a charging/discharging probe and a charging/discharging jig in the related art;

FIG. 3A to FIG. 3C are diagrams illustrating a charging/discharging probe and a charging/discharging jig according to embodiments of the present disclosure;

FIG. 4 is a diagram illustrating a circumstance in which the charging/discharging probe and the charging/discharging jig according to embodiments of the present disclosure include temperature measurement units;

FIGS. 5A and 5B are diagrams illustrating a circumstance in which the charging/discharging probe and the charging/discharging jig according to embodiments of the present disclosure include contact resistance measurement units; and

FIG. 6 is a diagram schematically illustrating a charging/discharging apparatus according to embodiments of the present disclosure.

### DETAILED DESCRIPTION

Exemplary embodiments of the present disclosure will be described below in detail with reference to the accompanying drawings. Prior to the description, it is noted that the terms or words used in this specification and claims should not be construed as being limited to common or dictionary meanings but instead should be understood to have meanings and concepts in agreement with the spirit of the present disclosure based on the principle that an inventor can define the concept of each term suitably in order to describe his/her own invention in the best way possible. Accordingly, since the embodiments described in this specification and the configurations illustrated in the drawings are only an example of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items.

The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below”may encompass both upward and downward directions.

The terminology used herein is for the purpose of describing embodiments of the present disclosure and is not intended to limit the present disclosure.

Examples of secondary batteries include a coin type, a cylindrical type, a prismatic type, and a pouch type. The present disclosure is basically applicable to a prismatic secondary battery. Therefore, the prismatic secondary battery will first be briefly described prior to description of embodiments of the present disclosure.

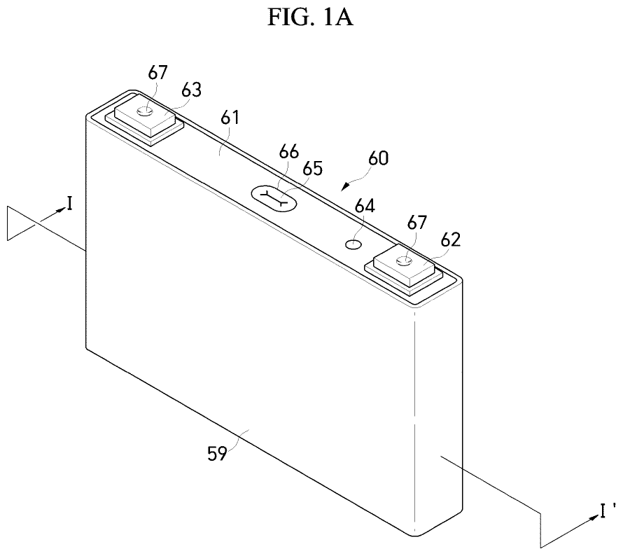

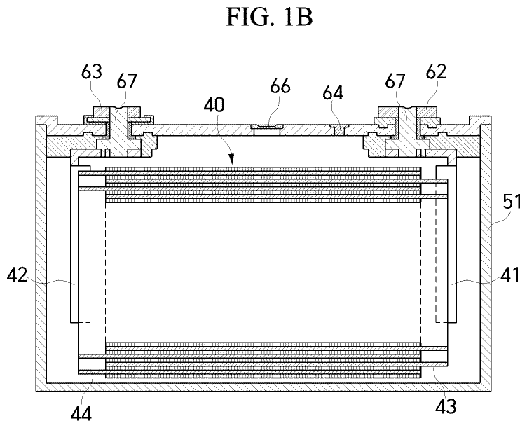

FIG. 1A is a top perspective view of the prismatic secondary battery. FIG. 1B is a cross-sectional view taken along line I-I′ of FIG. 1A.

First, the external appearance of the prismatic secondary battery illustrated in FIG. 1A will be described.

A casing 51 defines an overall appearance of the prismatic secondary battery, and may be made of conductive metal, such as aluminum, aluminum alloy, or nickel-plated steel. In addition, the casing 51 may provide a space for accommodating an electrode assembly therein.

A cap assembly 60 may include a cap plate 61 that covers the opening of the casing 51, and the cap assembly 60 and the cap plate 61 may be made of a conductive material. Here, a first terminal 63 and a second terminal 62 may be electrically connected to respective positive and negative (or negative and positive) electrodes inside the casing, and may be installed to protrude outward through the cap plate 61.

The cap plate 61 may be equipped with an electrolyte injection port 64 formed to install a sealing plug, and a vent 66 formed with a notch 65. The vent 66 is for degassing the secondary battery, i.e., for discharging gas generated inside the secondary battery.

With reference to FIG. 1B, the internal structure of the prismatic secondary battery and the coupling structure with the cap assembly 60 will be described.

As illustrated in FIG. 1B, the prismatic secondary battery may basically include an electrode assembly 40, a first current collector part 41, a first terminal 62, a second current collector part 42, a second terminal 63, and a cap assembly 60.

The electrode assembly 40 may be formed by winding or stacking a laminate of a first electrode plate, a separator, and a second electrode plate, which are in the form of a plate or a film. When the electrode assembly 40 is a wound laminate, it may have a winding axis parallel to the longitudinal direction of the casing. The electrode assembly 40 may be of a stack type rather than a winding type, but the shape of the electrode assembly 40 is not limited in the present disclosure. In addition, the electrode assembly 40 may be a Z-stack electrode assembly in which a first electrode plate and a second electrode plate are inserted into both sides of a separator bent into a Z-stack. Furthermore, the electrode assembly 40 may consist of one or more electrode assemblies, which are stacked such that their long sides are adjacent to each other and accommodated in the casing, and the number of electrode assemblies is not limited in the present disclosure. The electrode assembly 40 may have a first electrode plate that acts as a negative electrode and a second electrode plate that acts as a positive electrode, or vice versa.

The first electrode plate may be formed by applying a first electrode active material, such as graphite or carbon, to a first electrode current collector plate made of metal foil, such as copper, copper alloy, nickel, or nickel alloy. The first electrode plate may include a first electrode tab (or first uncoated part) 43, which is a region without application of the first electrode active material. The first electrode tab 43 may act as a current flow passage between the first electrode plate and the first current collector part 41. In some examples, the first electrode tab 43 may be formed by cutting the first electrode plate to protrude to one side in advance when manufacturing the first electrode plate, and may protrude further to one side than the separator without separate cutting.

The second electrode plate may be formed by applying a second electrode active material such as transition metal oxide to a substrate made of metal foil, such as aluminum or aluminum alloy. The second electrode plate may include a second electrode tab (or second uncoated part) 44, which is a region without application of the second electrode active material.

The second electrode tab 44 may act as a current flow passage between the second electrode plate and the second current collector part 42. In some examples, the second electrode tab 44 may be formed by cutting the second electrode plate to protrude to the other side in advance when manufacturing the second electrode plate, and may protrude further to the other side than the separator without separate cutting.

In some embodiments, the first electrode tab 43 may be located on the right end side of the electrode assembly 40, and the second electrode tab 44 may be located on the left end side of the electrode assembly 40. Alternatively, the first electrode tab 43 and the second electrode tab 44 may be located on one end side of the electrode assembly 40 in the same direction. Here, the left and the right are represented based on the secondary battery illustrated in FIG. 1 for convenience of explanation, and they may change in position when the secondary battery is rotated left and right or up and down.

The separator functions to prevent a short circuit between the first electrode plate and the second electrode plate while permitting migration of lithium ions therebetween. The separator may be made of, for example, a polyethylene film, a polypropylene film, a polyethylene-polypropylene film, or the like.

The first electrode tab 43 of the first electrode plate and the second electrode tab 44 of the second electrode plate extend from both ends of the electrode assembly 40 as described above, respectively. In some embodiments, the electrode assembly 40 may be accommodated together with an electrolyte in the casing 51.

In the electrode assembly 40, the first current collector part 41 and the second current collector part 42 may be welded and connected to the first electrode tab 43 extending from the first electrode plate and the second electrode tab 44 extending from the second electrode plate, respectively.

The first current collector part 41 and the second current collector part 42 are connected to the first terminal 62 and the second terminal 63, as described with reference to FIG. 1A, through terminal pins 67, respectively. In some embodiments, the terminal pins 67 may each have an outer peripheral surface that is threaded, and may be fastened to the first terminal 62 and the second terminal 63 by screwing. However, the present disclosure is not limited thereto. For example, the terminal pins 67 may also be coupled to the first terminal 62 and the second terminal 63 by riveting or welding.

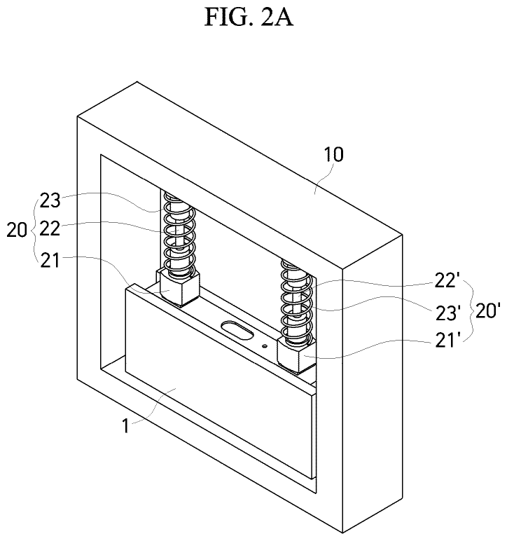

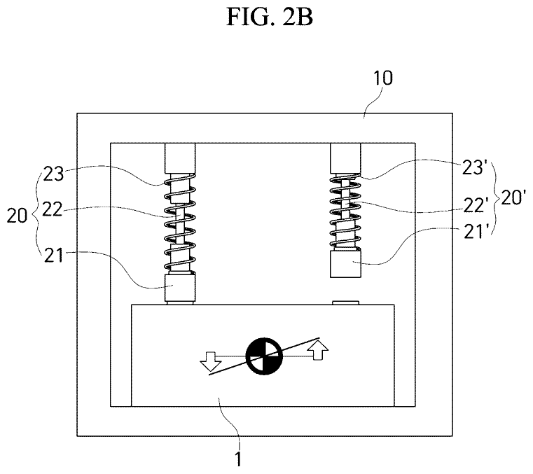

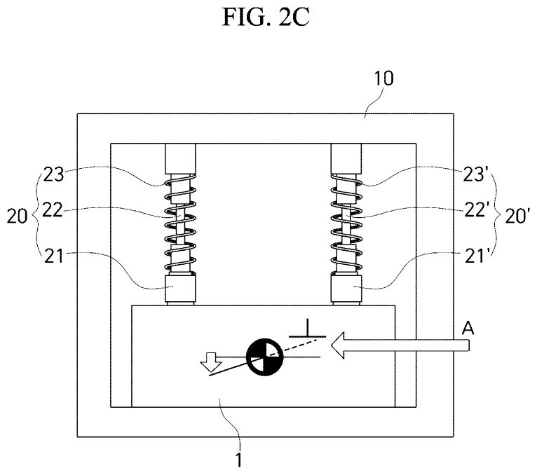

FIG. 2A to FIG. 2C are diagrams illustrating a charging/discharging probe and a charging/discharging jig in the related art.

Referring to FIGS. 2A to 2C, the charging/discharging jig in the related art may include a jig frame 10 on which a secondary battery 1 is mounted, and charging/discharging probes 20 and 20′.

The charging/discharging probe 20 may include a jig terminal 21, guide rod 22, and a spring 23, and the charging/discharging probe 20′ may include a jig terminal 21′, a guide rod 22′, and a spring 23′. The jig terminals 21 and 21′ contact electrode terminals of a secondary battery 1, and the guide rod 22 and 22′ and the spring 23 and 23′ serve to elastically fix the secondary battery 1. The guide rod 22 and 22′ of the charging/discharging jig in the related art each have a form fixed in a cylindrical shape.

As illustrated in FIG. 2B, the charging/discharging jig in the related art first aligns the position of one of the electrode terminals of the secondary battery 1 with the position of the charging/discharging probes 20, and then couples the remaining charging/discharging probes 20′ to the remaining one of the electrode terminals. However, a case of the secondary battery 1 is usually made of an aluminum plate, and when pressure is applied to the secondary battery 1 in order to align the position of the charging/discharging probe 20 with the position of the electrode terminal 20, deformation may occur in the case. Accordingly, an imbalance may occur between the electrode terminals of the secondary battery 1, and as a result, as illustrated in FIG. 2B, the horizontality between the electrode terminals may collapse.

As illustrated in FIG. 2C, when the remaining charging/discharging probe 20′ and the remaining electrode terminal are coupled in a state in which the horizontality between the electrode terminals collapses, since the guide rod 22′ of the charging/discharging probe 20′ is fixed in a cylindrical shape, the charging/discharging probe 20′ is lowered vertically and coupled to the electrode terminal whose horizontality collapses, as illustrated in FIG. 2A. That is, complete contact is not made between the jig terminal 21′ and the electrode terminal of the secondary battery, poor contact occurs, and thus additional contact resistance occurs. In such a circumstance, there is a problem in that the contact resistance between the charging/discharging probes 20 and 20′ and the electrode terminal is changed and charging/discharging or test is not possible.

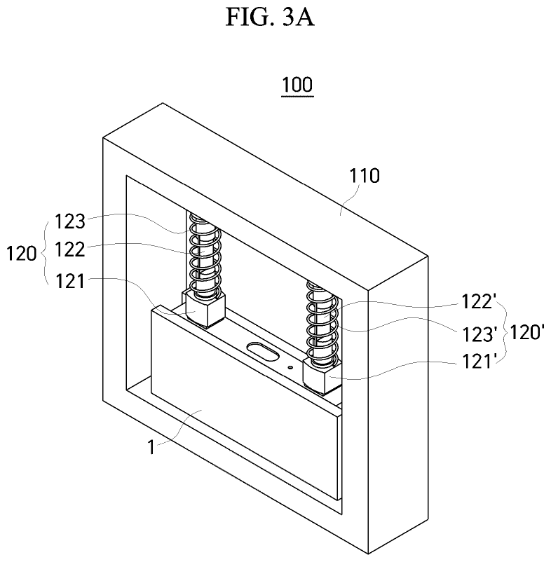

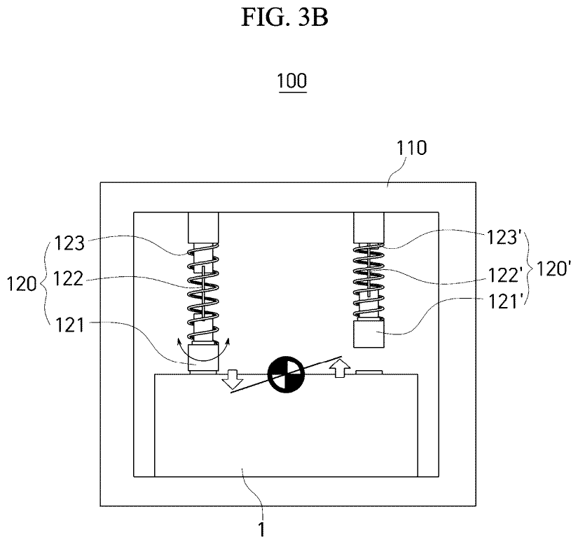

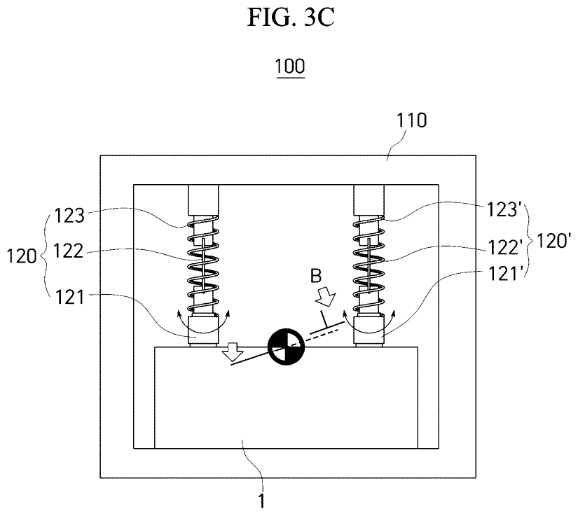

FIG. 3A to FIG. 3C are diagrams illustrating a charging/discharging probe and a charging/discharging jig according to embodiments of the present disclosure.

Referring to FIGS. 3A to 3C, a charging/discharging jig 100 according to embodiments of the present disclosure may include a jig frame 110 on which a secondary battery 1 is seated, and charging/discharging probes 120 and 120′ that contact electrode terminals of a secondary battery 1.

The charging/discharging probe 120 may include a jig terminal 121, a guide rod 122, and a spring 123, and the charging/discharging probe 120′ may include a jig terminal 121′, a guide rod 122′, and a spring 123′.

The jig terminals 121 and 121′ are electrically connected to the electrode terminals of the secondary battery 1 in contact with the electrode terminals.

The guide rods 122 and 122′ are coupled to connection portions with a frame 110 of the charging/discharging jig 100 and the jig terminals 121 and 121′, respectively, and are each made of an elastic member. In embodiments, the guide rods 122 and 122′ may each be a plate spring. As illustrated in FIG. 3A, grooves may be formed in the connection portions with the frame 110 and the jig terminals 121 and 121′, and the guide rods 122 and 122′ may be coupled to the grooves formed in the connection portions with the frame 110 and the jig terminals 121 and 121′. Since the guide rods 122 and 122′ are not a fixed type but are made of an elastic member that is easily bent left and right like a plate spring, even though the electrode terminals of the secondary battery 1 is not balanced, the guide rods 122 and 122′ may be bent together with the electrode terminals to achieve stable contact.

The springs 123 and 123′ allow the guide rods 122 and 122′ to elastically fix the electrode terminals of the secondary battery 1. In the charging/discharging probes 120 and 120′ according to embodiments of the present disclosure, when the guide rods 122 and 122′ are each a plate spring that provides elasticity in the left/right direction, the springs 123 and 123′ are each a coil spring that provides elasticity in the up/down direction to apply pressure to the electrode terminals of the secondary battery 1.

As illustrated in FIG. 3B, the charging/discharging jig 100 according to embodiments of the present disclosure first aligns the position of the charging/discharging probe 120 with the position of one of the electrode terminals of the secondary battery 1, and then couples the remaining charging/discharging probe 120′ and the remaining electrode terminal. As described above, when pressure is applied to the secondary battery 1 during this process, deformation may occur in a case, and accordingly, an imbalance may occur between the electrode terminals of the secondary battery 1, and as a result, as illustrated in FIG. 3B, the horizontality between the electrode terminals may collapse. However, even though such a phenomenon occurs, the charging/discharging probe 120 according to embodiments of the present disclosure can stably maintain contact between the jig terminal 121 and the electrode terminal of the secondary battery by allowing the guide rod 122 made of an elastic member to be bent left and right.

As illustrated in FIG. 3C, when the remaining charging/discharging probe 120′ and the remaining electrode terminal are coupled to each other in a state in which the horizontality between the electrode terminals collapses, since the guide rod 122′ of the charging/discharging probe 120′ is made of an elastic member, the guide rod 122′ is bent left and right as illustrated in FIG. 3B, thereby stably maintaining contact between the jig terminal 121′ and the electrode terminal of the secondary battery.

According to embodiments of the present disclosure, by providing the guide rods 122 and 122′ each made of an elastic member, poor contact between the charging/discharging probes 120 and 120′ and the electrode terminals due to the collapse of the horizontality between the electrode terminals of the secondary battery 1 can be prevented.

According to embodiments of the present disclosure, even though the horizontality of the electrode terminal of the secondary battery 1 collapses, the guide rods 122 and 122′ are each configured as a plate spring, so that the jig terminals 121 and 121′ can flexibly move left and right, thereby preventing poor contact and enabling smooth charging and discharging or test of the secondary battery 1.

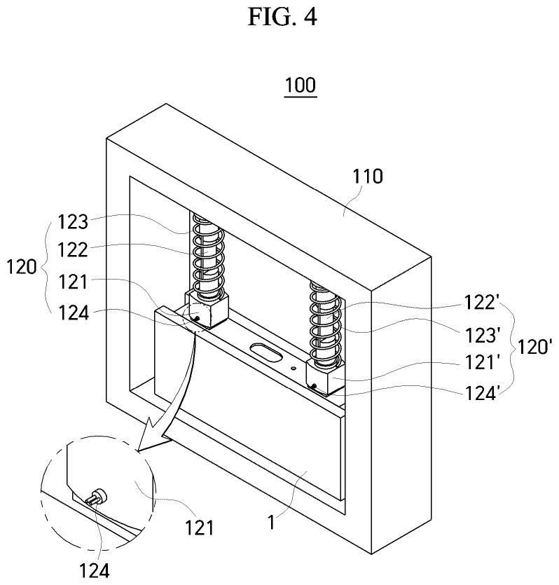

FIG. 4 is a diagram illustrating a circumstance in which the charging/discharging probe and the charging/discharging jig according to embodiments of the present disclosure include temperature measurement units.

Referring to FIG. 4, the charging/discharging probes 120 and 120′ according to embodiments of the present disclosure may include temperature measurement unit 124 and 124′, respectively. The temperature measurement unit 124 and 124′ may measure temperatures of the jig terminals 121 and 121′. When the contact of the jig terminals 121 and 121′ is poor, since a contact cross-sectional area decreases, a contact resistance increases, and the temperatures of the jig terminals 121 and 121′ increase, the temperature measurement unit 124 and 124′ may be provided to detect such an increase in temperature. In embodiments, the temperature measurement unit 124 and 124′ may each be a contact-type temperature sensor.

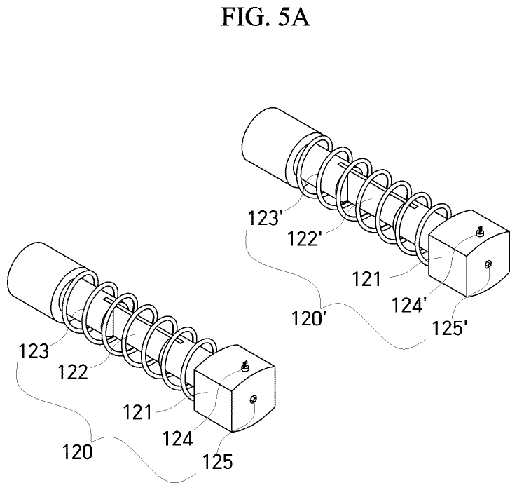

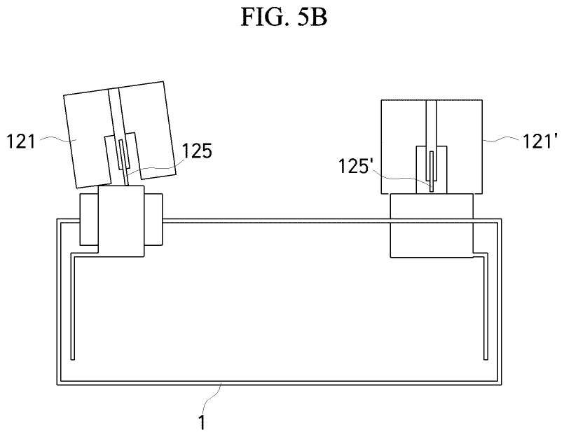

FIGS. 5A and 5B are diagrams illustrating a circumstance in which the charging/discharging probe and the charging/discharging jig according to embodiments of the present disclosure include contact resistance measurement units.

Referring to FIG. 5A and FIG. 5B, the charging/discharging probes 120 and 120′ according to embodiments of the present disclosure may include contact resistance measurement units (not illustrated), respectively. The jig terminals 121 and 121′ may include spring pogo pins 125 and 125′ on contact surfaces with the electrode terminals of the secondary battery 1, respectively. The spring pogo pins 125 and 125′ are each pins that make an electrical connection and are supported by internal springs. The spring pogo pins 125 and 125′ can stably maintain contact against vibration or shock due to the internal springs.

As illustrated in FIG. 5B, when the spring pogo pins 125 and 125′ come into contact with the electrode terminals of the secondary battery 1, the contact resistance measurement unit may measure contact resistances of the jig terminals 121 and 121′. In such a circumstance, as illustrated on the left, when the jig terminal 121 comes into incomplete contact with the electrode terminal of the secondary battery 1 in a state in which the horizontality of the electrode terminal of the secondary battery 1 collapses, since poor contact occurs and a contact cross-sectional area decreases, the contact resistance increases. As illustrated on the right, when the electrode terminal of the secondary battery 1 and the jig terminal 121 make proper contact, since the contact cross-sectional area increases, the contact resistance decreases.

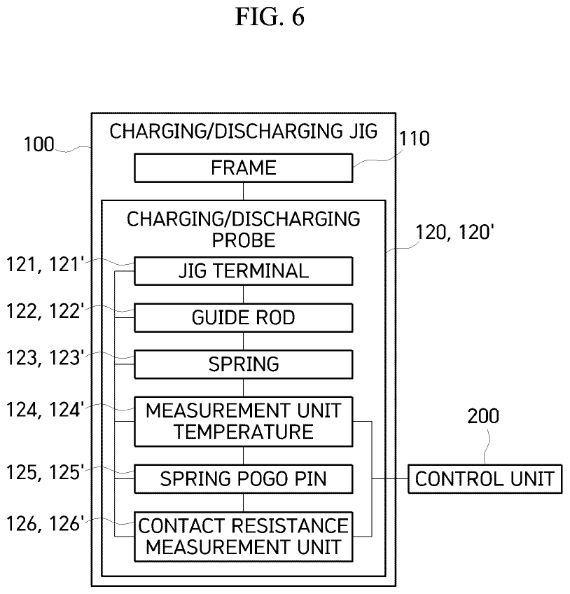

FIG. 6 is a diagram schematically illustrating a charging/discharging apparatus according to embodiments of the present disclosure.

Referring to FIG. 6, the charging/discharging apparatus according to embodiments of the present disclosure may include a charging/discharging jig 100 and a control unit 200.

The charging/discharging jig 100 is the same as the charging/discharging jig 100 described with reference to FIGS. 2A, 2B, 2C, 3A, 3B, 3C, 4, 5A, and 5B.

The control unit 200 controls charging, discharging, or test of the secondary battery 1. The control unit 200 may be connected to the charging/discharging jig 100 and may transmit and receive information related to the state of the secondary battery 1.

In embodiments, when the temperatures of the jig terminals 121 and 121′ are equal to or higher than a predetermined temperature value, the control unit 200 may determine that the contact between the jig terminals 121 and 121′ and the electrode terminals of the secondary battery 1 is poor. As described above, when the contact of the jig terminals 121 and 121′ is poor, the contact cross-sectional area decreases, the contact resistance increases, and accordingly, the temperatures of the jig terminals 121 and 121′ increase.

Therefore, when the temperatures of the jig terminals 121 and 121′ are equal to or higher than the predetermined temperature value, the control unit 200 may determine that the contact between the jig terminals 121 and 121′ and the electrode terminals of the secondary battery 1 is poor. The predetermined temperature value may be determined experimentally and may be set by a user as needed.

In embodiments, when the spring pogo pins 125 and 125′ come into contact with the electrode terminals of the secondary battery 1, the contact resistance measurement units 126 and 126′ measure the contact resistance of the jig terminals 121 and 121′, and when the contact resistance of the jig terminals 121 and 121′ is equal to or greater than a predetermined resistance value, the control unit 200 may determine that the contact between the jig terminals 121 and 121′ and the electrode terminals of the secondary battery 1 is poor. As described above, when the contact of the jig terminals 121 and 121′ is poor, since the contact cross-sectional area decreases and the contact resistance increases, the control unit 200 may determine that the contact between the jig terminals 121 and 121′ and the electrode terminals of the secondary battery 1 is poor when the contact resistance of the jig terminals 121 and 121′ is equal to or greater than the predetermined resistance value. The predetermined resistance value may be determined experimentally and may be set by a user as needed.

Hereinafter, materials which may be used in a secondary battery according to embodiments of the present disclosure are described.

A compound (e.g., a lithiated intercalation compound) capable of reversible intercalation and deintercalation of lithium may be used as a positive electrode active material. Specifically, one type or more selected among complex oxides of metal, selected among cobalt, manganese, nickel, and a combination of them, and lithium may be used as the positive electrode active material.

The complex oxide may be lithium transition metal complex oxide. A detailed example of the complex oxide may include lithium nickel-based Oxide, lithium cobalt-based oxide, lithium manganese-based oxide, a lithium ferrous phosphate-based compound, cobalt-free nickel-manganese-based oxide, or a combination of them.

For example, a compound that is represented as one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the chemical formula, A may be Ni, Co, Mn, or a combination of them. X may be Al, Ni, Co, Mn, Cr, Fe, Mg, Sr, V, a rare earth element, or a combination of them; D may be O, F, S, P, or a combination of them. G may be Al, Cr, Mn, Fe, Mg, La, Ce, Sr, V, or a combination of them. L¹ may be Mn, Al, or a combination of them.

A positive electrode for a lithium secondary battery may include a current collector and a positive electrode active material layer formed on the current collector. The positive electrode active material layer may include the positive electrode active material, and may further include a binder and/or a conductive material.

Content of the positive electrode active material may be 90 wt. % to 99.5 wt. % with respect to the positive electrode active material layer 100 wt. %. Content of the binder and the conductive material may be 0.5 wt. % to 5 wt. % with respect to the positive electrode active material layer 100 wt. %.

Al may be used as the current collector, but the present disclosure may not be limited thereto.

A negative electrode active material may include a material capable of reversibly Intercalation/de-intercalation with respect to lithium ions, lithium metal, an alloy of lithium metal, a material capable of doping and dedoping with respect to lithium, or transition metal oxide.

The material capable of reversibly Intercalation/de-intercalation with respect to lithium ions may include a carbon-based negative electrode active material, for example, crystalline carbon, amorphous carbon, or a combination of them. An example of the crystalline carbon may include graphite, such as natural graphite or synthetic graphite. Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0<x<2), a Si-based alloy, or a combination of them.

The silicon-carbon composite may be a composite of silicon and amorphous carbon. According to an implementation example, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material, and may further include a binder and/or a conductive material.

For example the negative electrode active material layer may include the negative electrode active material of 90 wt. % to 99 wt. %, the binder of 0.5 wt. % to 5 wt. %, and the conductive material of 0 wt. % to 5 wt. %.

A nonaqueous-based binder, an aqueous-based binder, a dry binder, or a combination of them may be used as the binder. If the aqueous-based binder is used as a binder for the negative electrode, the binder for the negative electrode may further include a cellulose-series compound capable of assigning viscosity.

One selected among nickel foil, stainless steel foil, titanium foil, nickel foam, copper foam, a polymer base on which a conductive metal has been coated, and a combination of them may be used as a current collector for the negative electrode.

An electrolyte for a lithium secondary battery may include a nonaqueous organic solvent and lithium salts.

The nonaqueous organic solvent may play a role as a medium through which ions that are involved in an electrochemical reaction of a battery can move.

The nonaqueous organic solvent may be a carbonate-based, ester-based, ether-based, ketone-based, or alcohol-based solvent, an aprotic solvent, or a combination of them. The carbonate-based, ester-based, ether-based, ketone-based, or alcohol-based solvent, or the aprotic solvent may be used solely, or two types or more of them may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer having two or more layers of them may be used as the separator.

The separator may include a porous base, and a coating layer including an organic matter, an inorganic matter, or a combination of them that is disposed on one or both sides of the porous base.

The organic matter may include a polyvinylidene fluoride-based heavy antibody or (meth) acrylic polymer.

The inorganic matter may include inorganic particles selected among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination of them, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked.

Although the present disclosure has been described above in connection with the limited embodiments and drawings, the present disclosure is not limited to the embodiments. A person having ordinary knowledge in the art to which the present disclosure pertains may modify and change the present disclosure within the technical spirit of the present disclosure and the equivalent range of the following claims.

What is claimed is:

1. A charging/discharging probe in contact with an electrode terminal of a secondary battery in a charging/discharging jig used for charging, discharging, or testing of the secondary battery, the charging/discharging probe comprising:
a jig terminal electrically connected to the electrode terminal of the secondary battery;
a guide rod coupled to a connection portion with a frame of the charge/discharge jig and the jig terminal and made of an elastic member; and
a spring formed to surround a part of the jig terminal and the guide rod and allowing the guide rod to elastically fix the electrode terminal of the secondary battery.

2. The charging/discharging probe as claimed in claim 1, wherein the guide rod is a plate spring.

3. The charging/discharging probe as claimed in claim 2, wherein the guide rod is coupled to a groove formed in the connection portion with the frame of the charge/discharge jig and the jig terminal.

4. The charging/discharging probe as claimed in claim 1, further comprising:
temperature measurement unit that measures a temperature of the jig terminal.

5. The charging/discharging probe as claimed in claim 1, further comprising:
a contact resistance measurement unit that measures a contact resistance of the jig terminal.

6. The charging/discharging probe as claimed in claim 5, wherein the jig terminal comprises:
a spring pogo pin on a contact surface with the electrode terminal of the secondary battery.

7. The charging/discharging probe as claimed in claim 6, wherein when the spring pogo pin comes into contact with the electrode terminal of the secondary battery, the contact resistance measurement unit measures the contact resistance of the jig terminal.

8. A charging/discharging jig used for charging, discharging, or testing of a secondary battery, comprising:
a frame on which the secondary battery is seated; and
a charging/discharging probe in contact with an electrode terminal of the secondary battery,
wherein the charging/discharging probe comprises: a jig terminal electrically connected to the electrode terminal of the secondary battery in contact with the electrode terminal; a guide rod coupled to a connection portion with a frame and the jig terminal and made of an elastic member; and a spring formed to surround a part of the jig terminal and the guide rod and allowing the guide rod to elastically fix the electrode terminal of the secondary battery.

9. The charging/discharging jig as claimed in claim 8, wherein the guide rod is a plate spring.

10. The charging/discharging jig as claimed in claim 9, wherein a groove is formed in the connection portion with the frame and the jig terminal, and
the guide rod is coupled to the groove formed in the connection portion with the frame and the jig terminal.

11. The charging/discharging jig as claimed in claim 8, wherein the charging/discharging probe further comprises:
a temperature measurement unit that measures temperature of the jig terminal.

12. The charging/discharging jig as claimed in claim 8, wherein the charging/discharging probe further comprises:
a contact resistance measurement unit that measures a contact resistance of the jig terminal.

13. The charging/discharging jig as claimed in claim 12, wherein the jig terminal comprises:
a spring pogo pin on a contact surface with the electrode terminal of the secondary battery.

14. The charging/discharging jig as claimed in claim 13, wherein when the spring pogo pin comes into contact with the electrode terminal of the secondary battery, the contact resistance measurement unit measures the contact resistance of the jig terminal.

15. A charging/discharging apparatus used for charging, discharging, or test of a secondary battery, comprising:
a charging/discharging jig comprising a frame on which the secondary battery is seated and a charging/discharging probe in contact with an electrode terminal of the secondary battery; and
a control unit that controls the charging, discharging, or test of the secondary battery,
wherein the charging/discharging probe comprises: a jig terminal electrically connected to the electrode terminal of the secondary battery in contact with the electrode terminal; a guide rod coupled to a connection portion with a frame and the jig terminal and made of an elastic member; and a spring formed to surround a part of the jig terminal and the guide rod and allowing the guide rod to elastically fix the electrode terminal of the secondary battery.

16. The charging/discharging apparatus as claimed in claim 15, wherein the charging/discharging probe further comprises:
a temperature measurement unit that measures a temperature of the jig terminal.

17. The charging/discharging apparatus as claimed in claim 16, wherein when the temperature of the jig terminal is equal to or higher than a predetermined temperature value, the control unit determines that a contact between the jig terminal and the electrode terminal of the secondary battery is poor.

18. The charging/discharging apparatus as claimed in claim 15, wherein the charging/discharging probe further comprises:
a contact resistance measurement unit that measures a contact resistance of the jig terminal.

19. The charging/discharging apparatus as claimed in claim 18, wherein the jig terminal comprises:
a spring pogo pin on a contact surface with the electrode terminal of the secondary battery.

20. The charging/discharging apparatus as claimed in claim 19, wherein when the spring pogo pin comes into contact with the electrode terminal of the secondary battery, the contact resistance measurement unit measures the contact resistance of the jig terminal, and when the contact resistance of the jig terminal is equal to or greater than a predetermined resistance value, the control unit determines that a contact between the jig terminal and the electrode terminal of the secondary battery is poor.
